(19) United States
(12) Patent Application Publication
(10) Pub. No.: US 2011/0106719 A1
(43) Pub. Date: May 5, 2011

(54) SYSTEM AND METHOD FOR MATCHING MOBILE DEVICE USERS

(75) Inventors: Han-Shuo Wang, Taipei City (TW); Cheng-Chang Liu, Taipei County (TW); Kuo-Shu Luo, Hsinchu City (TW)

(73) Assignee: INDUSTRIAL TECHNOLOGY RESEARCH INSTITUTE, Hsinchu (TW)

(21) Appl. No.: 12/648,307

(22) Filed: Dec. 29, 2009

(30) Foreign Application Priority Data
Oct. 30, 2009 (TW) 98136901

(51) Int. Cl. G06Q 99/00; H04W 64/00; G06Q 50/00; G06F 3/048; G06F 21/00

(52) U.S. Cl. 705/319; 455/456.3; 715/764; 726/1

(57) ABSTRACT

A system and a method for matching mobile device users are provided. The system includes a match server and a mobile device used by a mobile device user. The match server defines a plurality of living community regions, living community reference points, primary interest classes and detail interest classes, receives position coordinates from the mobile device, and defines a living community range of the mobile device user and infers the point of interest (POI) of the mobile device user based on the received position coordinates. Moreover, the match server generates a match list based on the living community ranges, the POIs and the personal profiles of the mobile device user and the other mobile device users, and transmits the match list to the mobile device. Accordingly, the system can effectively match the mobile device users having similar behavior patterns.

### CROSS-REFERENCE TO RELATED APPLICATION

This application claims the priority benefit of Taiwan application serial no. 98136901, filed on Oct. 30, 2009. The entirety of the above-mentioned patent application is hereby incorporated by reference herein and made a part of specification.

### BACKGROUND

1. Field

The disclosure relates to a system and a method for matching mobile device users.

2. Description of Related Art

As communication methods between people are varied, conventional dating services such as special medias and pen pals have been gradually replaced by novel date matching service mechanisms such as phone dating, Internet dating, and auto match information devices, etc.

In a current people matching or classifying application service (for example, a date matching website), classifications or matches of users are simply performed according to personal information registered by the users. Such simple personal information cannot completely describe a background of a matched user. Moreover, since the users can arbitrarily input their personal information, a user desired to use such match service cannot confirm the authenticity of the personal information of the others. Therefore, for the user desired to use the match service, the personal information of the others have non-reference value, or probably, the user desired to use the match service is afraid of being cheated, and does not want to make a further contact or chat with the others according to such personal information.

Particularly, according to a geographic classification, the current match service simply record an administrative area where the user is located, which is excessively sketchy and lack of dynamic update. For example, when a user 1 lives in a place A, and a user 2 lives in a place B, the users 1 and 2 are probably not considered as a suitable match by the current match service. However, if both of the users 1 and 2 often conduct activities at a place C, the users 1 and 2 belonged to a same living community are probably a rather suitable match. Therefore, if an activity track or a living community of the user can be truly and dynamically recorded, a more reliable and detailed background information of the user can be provided, which avails the user desired to use the match service trusting the personal information of the others provided by the match service, so that the user is probably willing to use match results generated by the match service to make a further contact with the others.

### SUMMARY

The disclosure is directed to a system and a method for matching mobile device users, which can match the mobile device users having similar behavior patterns according to actual behavior patterns of the mobile device users.

The disclosure provides a system for matching mobile device users. The system includes a mobile device and a match server. The mobile device is used by a mobile device user. The match server receives a plurality of position coordinates of the mobile device user from the mobile device, and transmits a match list to the mobile device. The match serve includes a living community range defining module, a point of interest (POI) inferring module, a personal profile maintaining module, a mobile device user database, a match engine module and a match list transmission module. The living community range defining module defines a plurality of living community regions and a plurality of living community reference points in each of the living community regions, and defines a living community range of the mobile device user according to the position coordinates of the mobile device user and the living community reference points and the living community regions. The POI inferring module defines a plurality of primary interest classes and a plurality of detail interest classes in each of the primary interest classes, and infers a POI of the mobile device user according to the position coordinates of the mobile device user and the defined primary interest classes and the detail interest classes. The personal profile maintaining module provides a registration for the mobile device user, and maintains personal profiles of the mobile device user. The mobile device user database stores the living community range, the POI and the personal profiles of the mobile device user, and further stores living community ranges, POIs and personal profiles of a plurality of other mobile device users. The match engine module calculates a match index between the mobile device user and each of the other mobile device users according to the living community range, the POI and the personal profiles of the mobile device user and the living community ranges, the POIs and the personal profiles of the other mobile device users. The match list transmission module generates the match list according to the calculated match indexes and transmits the match list to the mobile device, wherein the personal profiles of at least one of the other mobile device users are listed in the match list.

The disclosure provides a method for matching mobile device users. The method includes receiving a plurality of position coordinates of a mobile device user from a mobile device, wherein the mobile device is used by the mobile device user. The method also includes defining a plurality of living community regions and a plurality of living community reference points in each one of the living community regions, and defining a living community range of the mobile device user according to the position coordinates of the mobile device user and the defined living community reference points and the living community regions. The method still includes defining a plurality of primary interest classes and a plurality of detail interest classes in each of the primary interest classes, and inferring a POI of the mobile device user according to the position coordinates of the mobile device user and the defined primary interest classes and the detail interest classes. The method still includes storing the living community range, the POI and personal profiles of the mobile device user in a mobile device user database, wherein the mobile device user database further stores living community ranges, POIs and personal profiles of a plurality of other mobile device users. The method still includes calculating a match index between the mobile device user and each of the other mobile device users according to the living community range, the POI and the personal profiles of the mobile device user and the living community ranges, the POIs and the personal profiles of the other mobile device users. The method further includes generating a match list according to the calculated match indexes, and transmitting the match list to the mobile device, wherein the personal profiles of at least one of the other mobile device users are listed in the match list.

According to the above descriptions, the system and the method for matching the mobile device users of the disclosure can provide the mobile device users match services more in accord with actual behavior patterns of the mobile device users.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1-3 are schematic diagrams illustrating a system for matching mobile device users according to an exemplary embodiment of the disclosure.

FIG. 4 is a schematic block diagram illustrating a mobile device according to an exemplary embodiment of the disclosure.

FIG. 5 is a schematic block diagram illustrating a match server according to an exemplary embodiment of the disclosure.

FIG. 6 is a diagram illustrating an example of calculating a match index according to living community reference points and living community regions according to an exemplary embodiment of the disclosure.

FIG. 7 is a diagram illustrating an example of calculating a match index according to detail interest classes and primary interest classes according to an exemplary embodiment of the disclosure.

FIG. 8 is a diagram illustrating an example of calculating a match index according to personal profile attribute classes according to an exemplary embodiment of the disclosure.

FIG. 9 is a flowchart illustrating a method for matching mobile device users according to an exemplary embodiment of the disclosure.

FIG. 10 is a flowchart illustrating a process of gradually disclosing closed personal profiles according to a privacy setting according to an exemplary embodiment of the disclosure.

### DESCRIPTION OF THE EXEMPLARY EMBODIMENTS

Reference will now be made in detail to the present preferred exemplary embodiments of the invention, examples of which are illustrated in the accompanying drawings. Wherever possible, the same reference numbers are used in the drawings and the description to refer to the same or like parts.

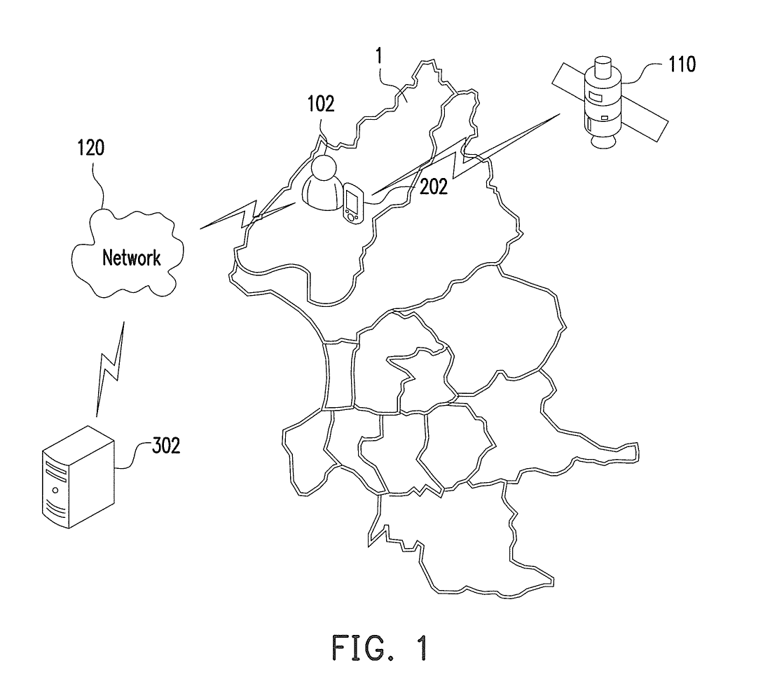

FIG. 1, FIG. 2 and FIG. 3 are schematic diagrams illustrating a system for matching mobile device users according to an exemplary embodiment of the disclosure.

Referring to FIG. 1, FIG. 2 and FIG. 3, in the present exemplary embodiment, basic personal profiles of a mobile device user 102 are registered in a match server 302 in advance. Here, the mobile device user 102 uses a mobile device 202 to connect the match server 302 through a network 120 (for example, the Internet) to perform the registration in a wireless approach. However, the disclosure is not limited thereto, and the mobile device user 102 can also use a network terminal (for example, a personal computer) to connect the match server 302 through the network 120 to perform the registration in a cable approach.

When the mobile device user 102 enables a match service in the mobile device 202, the mobile device 202 receives position coordinates of a current position from a global positioning system (GPS) 110, and transmits the position coordinates to the match server 302. For example, when the mobile device user 102 is located in a geographic region 1, the mobile device 202 transmits the position coordinates of the mobile device user 102 to the match server 302. When the mobile device user 102 is located in a geographic region 2, the mobile device 202 transmits the position coordinates of the mobile device user 102 to the match server 302. Moreover, when the mobile device user 102 is located in a geographic region 3, the mobile device 202 transmits the position coordinates of the mobile device user 102 to the match server 302. Namely, in every a time interval, the match server 302 receives the position coordinates of the mobile device user 102, and integrally records an activity track of the mobile device user 102, so as to dynamically define a living community range and a point of interest (POI) of the mobile device user 102.

Particularly, the match server 302 can generate a match list according to the living community range, the POI and the personal profiles of the mobile device user 102, and transmits the generated match list to the mobile device 202, wherein the match list comprises personal profiles of the other mobile device users having similar behavior patterns with that of the mobile device user 102. Namely, when a plurality of the mobile device users registers in the match server 302, and after mobile devices used by the mobile device users transmit corresponding position coordinates of the mobile device users to the match server 302, the match server 302 defines and records living community ranges and POIs of all of the mobile device users according to actual behavior patterns of the mobile device users, and matches the mobile device users having similar actual behavior patterns, so as to provide the match service to the mobile device users.

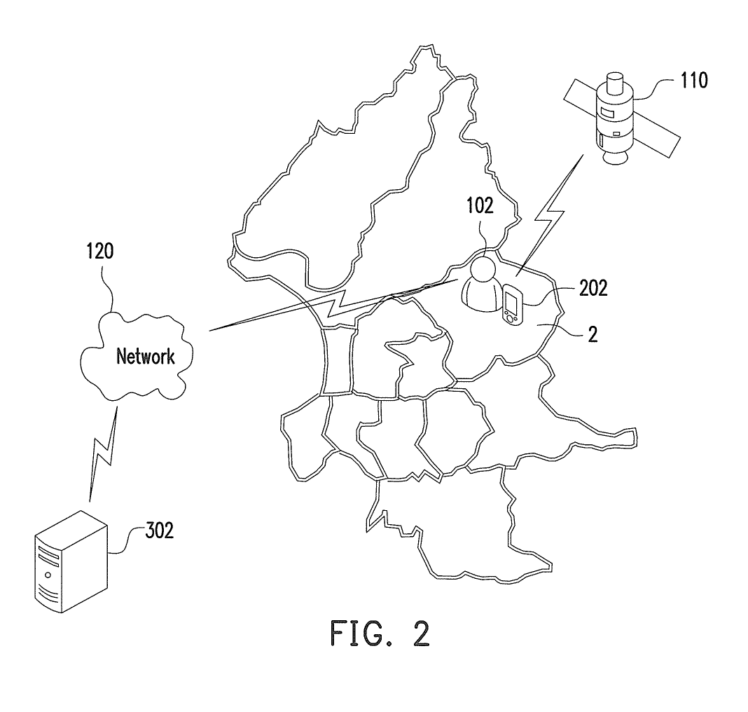

FIG. 4 is a schematic block diagram illustrating a mobile device according to an exemplary embodiment of the disclosure.

Referring to FIG. 4, the mobile device 202 includes a micro processor unit 204, a positioning unit 206, a wireless network unit 208, a display unit 210, a memory 212, an input unit 214 and a match service module 216.

The micro processor unit 204 is configured for controlling a whole operation of the mobile device 202.

The positioning unit 206 is electrically connected to the micro processor unit 204, and is configured for obtaining the position coordinates of the mobile device 202, i.e. the position coordinates of the mobile device user 102 using the mobile device 202. In the present exemplary embodiment, the positioning unit 206 is a GPS receiver used for receiving the position coordinates from the GPS 110. However, it should be notice that the disclosure is not limited thereto, and the positioning unit 206 can also be other devices that can obtain the position coordinates.

The wireless network unit 208 is electrically connected to the micro processor unit 204, and is configured for providing a wireless network transmission function. For example, the wireless network unit 208 transmits the position coordinates obtained by the positioning unit 206 to the match server 302 through the network 120, and receives the match list from the match server 302 through the network 120.

The display unit 210 is electrically connected to the micro processor unit 204, and is configured for displaying the match list received from the match server 302. For example, the display unit 210 is a liquid crystal display unit.

The memory 210 is electrically connected to the micro processor unit 204, and is configured for storing data. For example, the memory 212 is a flash memory or other suitable storage devices.

The input unit 214 is electrically connected to the micro processor unit 204, and the mobile device user 102 inputs data through the input unit 214. For example, the mobile device user 102 uses the input unit 214 to select the mobile device users listed in the match list.

The match service module 216 is electrically connected to the micro processor unit 204, and is configured for activating the match service provided by the match server 302. For example, when the mobile device user 102 enables the match service module 216, the match service module 216 transmits the current position coordinates obtained by the positioning unit 206 to the match server 302 according to an instruction of the mobile device user 102. Moreover, when the wireless network unit 208 receives the match list from the match server 302, the match service module 216 displays the received match list on the display unit 210, and allows the mobile device user 102 selecting the mobile device users listed in the match list.

In the present exemplary embodiment, the match service module 216 is implemented as a hardware form, though the disclosure is not limited thereto, and the match service module 216 can also be implemented as a software application program. In another exemplary embodiment of the disclosure, the match service module 216 implemented as a software application program is stored in the memory 212, and is executed by the micro processor unit 204.

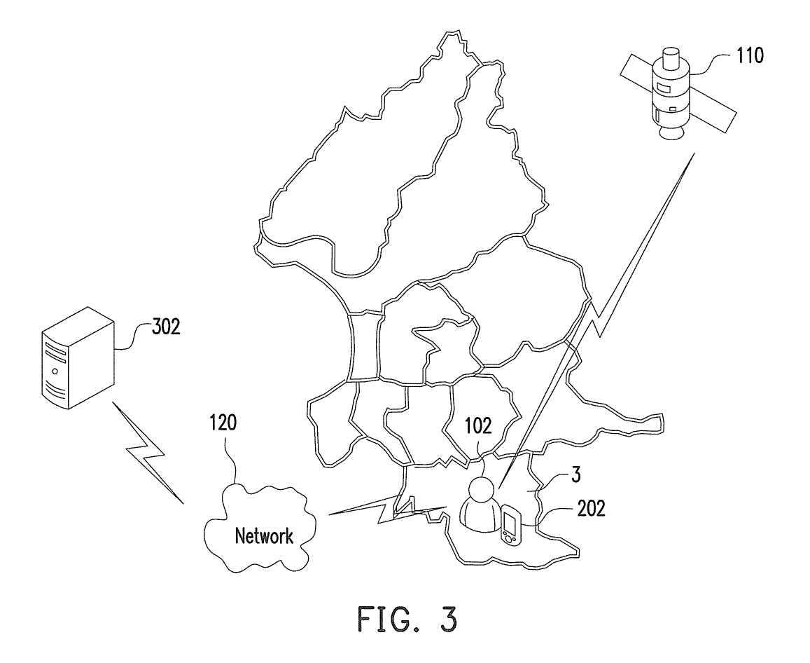

FIG. 5 is a schematic block diagram illustrating a match server according to an exemplary embodiment of the disclosure.

Referring to FIG. 5, the match server 302 includes a wireless network unit 502, a living community range defining module 504, a POI inferring module 506, a personal profile maintaining module 508, a mobile device user database 510, a match engine module 512 and a match list transmission module 514.

The wireless network unit 502 receives the position coordinates of the mobile device user 102 from the mobile device 202, and transmits the match list to the mobile device 202.

The living community range defining module 504 defines a plurality of living community regions and a plurality of living community reference points in each of the living community regions, and defines a living community range of the mobile device user according to the position coordinates of the mobile device user and the defined living community reference points and the living community regions. In detail, the living community range defining module 504 divides a geographic map into different living community regions. For example, each of the living community regions is consisted of county (city) administrative areas or township (town) administrative areas. Moreover, the living community range defining module 504 further divides each of the living community regions into a plurality of the living community reference points. For example, each of the living community reference points can be consisted of business areas, station areas, or postal codes, etc. In the present exemplary embodiment, the living community range defining module 504 can recognize the living community reference point and the living community region corresponding to the position coordinates of the mobile device user, and accordingly defines the living community range of the mobile device user. For example, when the living community range defining module 504 receives the position coordinates of the mobile device user 102 from the mobile device 202, the living community range defining module 504 recognizes the living community region and the living community reference point closest to such position coordinates, and accordingly defines the living community range of the mobile device user 102. Namely, the living community range defining module 504 recognizes the living community region and the living community reference point corresponding to the position coordinates according to a distance between the position coordinates and the defined living community regions and the living community reference points.

It should be noticed that in the present exemplary embodiment, the living community range of the mobile device user is defined according to the living community reference points and the living community regions. However, the disclosure is not limited thereto, and in another exemplary embodiment, the living community region can be further divided into a primary living community region and a secondary living community region, so as to define the living community range of the mobile device user in detail.

The POI inferring module 506 defines a plurality of primary interest classes and a plurality of detail interest classes in each of the primary interest classes, and infers a POI of the mobile device user according to the position coordinates of the mobile device user and the defined primary interest classes and the detail interest classes. In detail, the POI inferring module 506 defines a plurality of the primary interest classes, for example, drinking coffee, sports, shopping, etc. Moreover, the POI inferring module 506 defines a plurality of the detail interest classes in each of the primary interest classes. For example, the primary interest class of drinking coffee includes the detail interest classes of Starbucks Coffee, 85° C. Coffee and Seattle Coffee, etc. Particularly, the POI inferring module 506 infers the primary interest class of the mobile device user according to the position coordinates of the mobile device user. For example, when the position coordinates of the mobile device user is appeared at a coffee shop (i.e. a distance between the position coordinate and coordinates of a predetermined coffee shop is within a certain range (for example, 5 meters)), the POI inferring module 506 infers that the mobile device user likes drinking coffee, and meanwhile the POI inferring module 506 records whether the mobile device user is appeared at the Starbucks Coffee shop, the 85° C. Coffee shop or the Seattle Coffee shop.

The personal profile maintaining module 508 provides the registration for the mobile device user, and maintains the personal profiles of the mobile device user. For example, in an exemplary embodiment of the disclosure, the personal profile maintaining module 508 provides a website (or a web page) that can be accessed by the mobile device user 102, and the mobile device user 102 accesses this website through the network 120 to register basic personal profiles of the mobile device user in an input interface of the website. Alternatively, in another exemplary embodiment of the disclosure, the mobile device user 102 can use the input unit 214 to input the personal profiles in an input interface of the match service module 216, and transmits it to the personal profile maintaining module 508. Here, the mobile device user can set the registered basic personal profiles as open personal profiles or closed personal profiles, wherein all of the user can browse the open personal profiles, and only the privileged users can browse the closed personal profiles.

It should be noticed that the website provided by the personal profile maintaining module 508 also includes a plurality of interactive question and answer interfaces or a plurality of interactive game interfaces (for example, a psychological test). Moreover, detail personal profiles of the mobile device user can be established via the interactive question and answer interfaces or the interactive game interfaces. For example, the personal profile maintaining module 508 respectively divides a personality trait attribute, an attribute of views of current affairs, and a personal lifestyle attribute into a plurality of classes, and classifies the mobile device user into one of the classes in each of the attributes via the interactive question and answer interfaces or the interactive game interfaces. Here, the detail personal profiles of the mobile device user generated by the interactive question and answer interfaces or the interactive game interfaces are configured as the closed personal profiles.

The mobile device user database 510 stores the living community ranges, the POIs and the personal profiles of a plurality of the mobile device users. In detail, the personal profiles input by the mobile device user 102 through the personal profile maintaining module 508 and the living community range and the POI generated by the living community range defining module 504 and the POI inferring module 506 according to the position coordinates of the mobile device user 102 are stored in the mobile device user database 510.

The match engine module 512 calculates match indexes among the mobile device users according to the stored living community ranges, the POIs and the personal profiles of the mobile device users, and the match lists are generated according to the calculated match indexes.

The match list transmission module 514 generates the match list according to the match index calculated by the match engine module 512, wherein the match list lists the mobile device users and their open personal profiles that are matched to the mobile device user 102 desired to receive the match service. Moreover, the match list transmission module 514 transmits the match list to the mobile device 202 of the mobile device user 102 through the wireless network unit 502.

Please amend paragraphs [0045] through [0060] in the originally filed specification as indicated hereinafter.

In the present exemplary embodiment, the match engine module 512 calculates the match index between two mobile device users according to a following equation (1):

$$MATCH ( a , b ) = {R}_{1} \times \frac{\begin{matrix}{\sum }_{{n}_{a} = 1}^{{n}_{{a}_{1}}} {\sum }_{{n}_{b} = 1}^{{n}_{{b}_{1}}} {α}_{1} \times \\ ( Numbersof ( ref ( {x}_{{a}_{{n}_{a}}} , {y}_{{a}_{{n}_{a}}} ) = ref ( {x}_{{a}_{{n}_{b}}} , {y}_{{a}_{{n}_{b}}} ) ) )\end{matrix}}{{n}_{{a}_{1}} \times {n}_{{b}_{1}}} + {R}_{2} \times \frac{\begin{matrix}{\sum }_{{n}_{a} = 1}^{{n}_{{α}_{1}}} {\sum }_{{n}_{b} = 1}^{{n}_{{b}_{1}}} {a}_{2} \times \\ ( Numbersof ( town ( {x}_{{a}_{{n}_{a}}} , {y}_{{a}_{{n}_{a}}} ) = town ( {x}_{{a}_{{n}_{b}}} , {y}_{{a}_{{n}_{b}}} ) ) )\end{matrix}}{{n}_{{a}_{1}} \times {n}_{{b}_{1}}} + {R}_{3} \times \frac{\begin{matrix}{\sum }_{{n}_{a} = 1}^{{n}_{{a}_{3}}} {\sum }_{{n}_{b} = 1}^{{n}_{{b}_{3}}} {a}_{3} \times \\ ( Numbersof ( POI ( {x}_{{a}_{{n}_{a}}} , {y}_{{a}_{{n}_{a}}} ) = POI ( {x}_{{a}_{{n}_{b}}} , {y}_{{a}_{{n}_{b}}} ) ) )\end{matrix}}{{n}_{{a}_{3}} \times {n}_{{b}_{3}}} + {R}_{4} \times \frac{\begin{matrix}{\sum }_{{n}_{a} = 1}^{{n}_{{a}_{3}}} {\sum }_{{n}_{b} = 1}^{{n}_{{b}_{3}}} {a}_{4} \times \\ ( Numbersof ( category ( {POI}_{{a}_{{n}_{a}}} ) = category ( {POI}_{{a}_{{n}_{b}}} ) ) )\end{matrix}}{{n}_{{a}_{3}} \times {n}_{{b}_{3}}} + {R}_{5} \times \frac{\begin{matrix}{\sum }_{{n}_{a} = 1}^{{n}_{{a}_{5}}} {\sum }_{{n}_{b} = 1}^{{n}_{{b}_{5}}} {a}_{5} \times \\ ( Numbersof ( class ( {personality}_{{a}_{{n}_{a}}} ) = class ( {personality}_{{a}_{{n}_{b}}} ) ) )\end{matrix}}{{n}_{{a}_{5}} \times {n}_{{b}_{5}}} \qquad ( 1 )$$

The parameters of the equation (1) are explained as follows:

| Parameter name | Description |
|---|---|
| MATCH(a, b) | a match index between a mobile device user a |
| | and a mobile device user b, which is generated |
| | according to the living community ranges |
| | (i.e. the living community reference points |
| | and the living community regions), the POIs |
| | (i.e. the detail interest classes and the primary |
| | interest classes) and the personal profiles |
| | (i.e. the personal profile attribute classes) of |
| | the mobile device user a and the mobile device |
| | user b that are stored in the mobile device user |
| | database 510 |
| $ref ( {x}_{{a}_{{n}_{a}}} , {y}_{{a}_{{n}_{a}}} )$ | the living community reference points of the mobile device user a |
| $ref ( {x}_{{a}_{{n}_{b}}} , {y}_{{a}_{{n}_{b}}} )$ | the living community reference points of the mobile device user b |
| $\begin{matrix}Numbers of ( ref ( {x}_{{a}_{{n}_{a}}} , {y}_{{a}_{{n}_{a}}} ) = \\ ref ( {x}_{{a}_{{n}_{b}}} , {y}_{{a}_{{n}_{b}}} ) )\end{matrix}$ | the number of the common living community reference points of the mobile device user a and the mobile device user b. |
| nₐ_{₁} | the number of data batches of the position |
| | coordinates of the mobile device user a that are |
| | recorded in the mobile device user database 510 |
| n_{b}_{₁} | the number of data batches of the position |
| | coordinates of the mobile device user b that are |
| | recorded in the mobile device user database 510 |
| $town ( {x}_{{a}_{{n}_{a}}} , {y}_{{a}_{{n}_{a}}} )$ | the living community regions of the mobile device user a |
| $town ( {x}_{{a}_{{n}_{b}}} , {y}_{{a}_{{n}_{b}}} )$ | the living community regions of the mobile device user b |
| $\begin{matrix}Numbers of ( town ( {x}_{{a}_{{n}_{a}}} , {y}_{{a}_{{n}_{a}}} ) = \\ town ( {x}_{{a}_{{n}_{b}}} , {y}_{{a}_{{n}_{b}}} ) )\end{matrix}$ | the number of the common living community regions of the mobile device user a and the mobile device user b |
| $POI ( {x}_{{a}_{{n}_{a}}} , {y}_{{a}_{{n}_{a}}} )$ | the detail interest classes of the mobile device user a |
| $POI ( {x}_{{a}_{{n}_{b}}} , {y}_{{a}_{{n}_{b}}} )$ | the detail interest classes of the mobile device user b |
| $\begin{matrix}Numbers of ( POI ( {x}_{{a}_{{n}_{a}}} , {y}_{{a}_{{n}_{a}}} ) = \\ POI ( {x}_{{a}_{{n}_{b}}} , {y}_{{a}_{{n}_{b}}} ) )\end{matrix}$ | the number of the common detail interest classes of the mobile device user a and the mobile device user b |
| nₐ_{₃} | the number of data batches of the POIs of the |
| | mobile device user a that are recorded in the |
| | mobile device user database 510 |
| n_{b}_{₃} | the number of data batches of the POIs of the |
| | mobile device user b that are recorded in the |
| | mobile device user database 510 |
| $category ( {POI}_{{a}_{{n}_{a}}} )$ | the primary interest classes of the mobile device user a |
| $category ( {POI}_{{a}_{{n}_{b}}} )$ | the primary interest classes of the mobile device user b |
| $\begin{matrix}Numbers of ( category ( {POI}_{{a}_{{n}_{a}}} ) = \\ category ( {POI}_{{a}_{{n}_{b}}} ) )\end{matrix}$ | the number of the common primary interest classes of the mobile device user a and the mobile device user b |
| $class ( {personality}_{{a}_{{n}_{a}}} )$ | the personal profile attribute classes of the mobile device user a |
| $class ( {personality}_{{a}_{{n}_{b}}} )$ | the personal profile attribute classes of the mobile device user b |
| $\begin{matrix}Numbers of ( class ( {personality}_{{a}_{{n}_{a}}} ) = \\ class ( {personality}_{{a}_{{n}_{b}}} ) )\end{matrix}$ | the number of the common personal profile attribute classes of the mobile device user a and the mobile device user b |
| nₐ_{₅} | the number of data batches of the personal |
| | profile attribute classes of the mobile device |
| | user a that are recorded in the mobile device |
| | user database 510 |
| n_{b}_{₅} | the number of data batches of the personal |
| | profile attribute classes of the mobile device |
| | user b that are recorded in the mobile device |
| | user database 510 |
| α₁ | the normalization weight of the number of the |
| | common living community reference points |
| α₂ | the normalization weight of the number of |
| | the common living community regions |
| α₃ | the normalization weight of the number of |
| | the common detail interest classes |
| α₄ | the normalization weight of the number of |
| | the common primary interest classes |
| α₅ | the normalization weight of the number of |
| | the common personal data attribute classes |
| R₁ | the calculation weight of the number of the |
| | common living community reference points |
| R₂ | the calculation weight of the number of the |
| | common living community regions |
| R₃ | the calculation weight of the number of the |
| | common detail interest classes |
| R₄ | the calculation weight of the number of the |
| | common primary interest classes |
| R₅ | the calculation weights of the number of the |
| | common personal data attribute classes |

Herein, the normalization weights and the calculation weights are used for calculating the match indexes. And, α₁, α₂, α₃, α₄, α₅, R₁, R₂, R₃, R₄ and R₅ can be any suitable value.

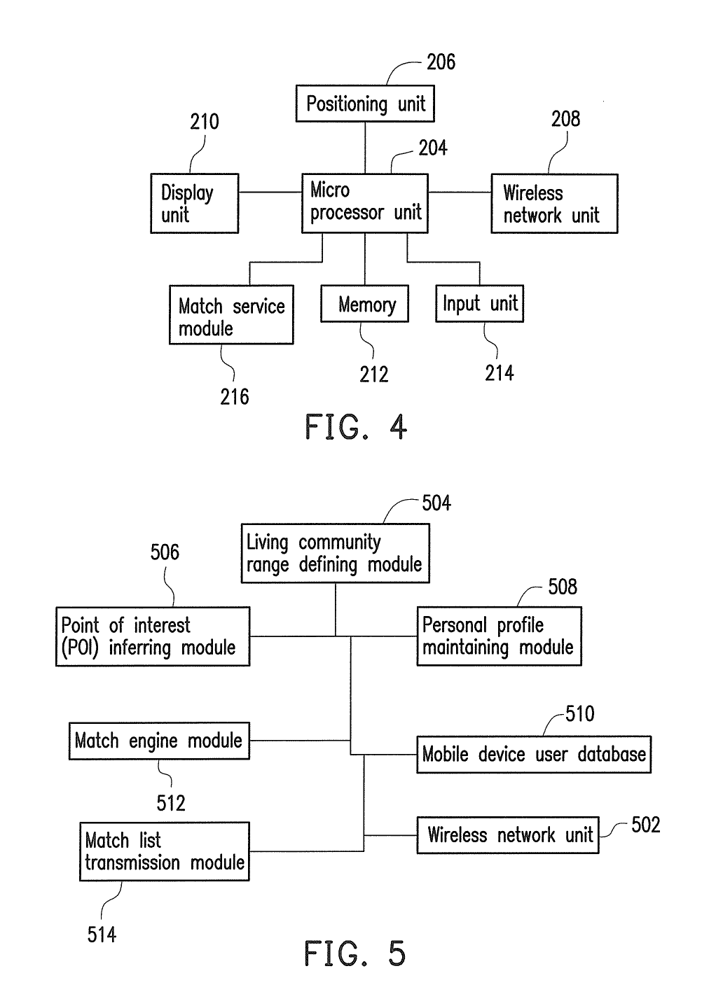

FIG. 6 is a diagram illustrating an example of calculating a match index according to the living community reference points and the living community regions according to an exemplary embodiment of the disclosure.

Referring to FIG. 6, in the present example, it is assumed that a living community region 601 includes living community reference points 601-1, 601-2, 601-3 and 601-4; a living community region 604 includes living community reference points 604-1, 604-2, 604-3 and 604-4; and according to the living community reference points and the living community regions corresponding to the position coordinates transmitted by the mobile devices of the mobile device users 102, 104, 106 and 108, it is analysed that the mobile device user 102 is ever appeared at the living community reference point 601-1 of the living community region 601; the mobile device user 104 is ever appeared at the living community reference point 604-1 of the living community region 604; the mobile device user 106 is ever appeared at the living community reference point 601-1 of the living community region 601; and the mobile device user 108 is ever appeared at the living community reference point 601-2 of the living community region 601. In the example shown in FIG. 6, when the match engine module 512 calculates the match index according to the equation (1), a score between the mobile device user 102 and the mobile device user 106 is the highest, a score between the mobile device user 102 and the mobile device user 108 is the secondary highest, and a score between the mobile device user 102 and the mobile device user 104 is 0. Namely, when the match server 302 provides the match service to the mobile device user 102, the match engine module 512 calculates the number of the common living community regions and the number of the common living community regions between the mobile device users 102 and 104, the mobile device users 102 and 106, and the mobile device users 102 and 108, so as to calculate the match index between the mobile device user 102 and each of the other mobile device users.

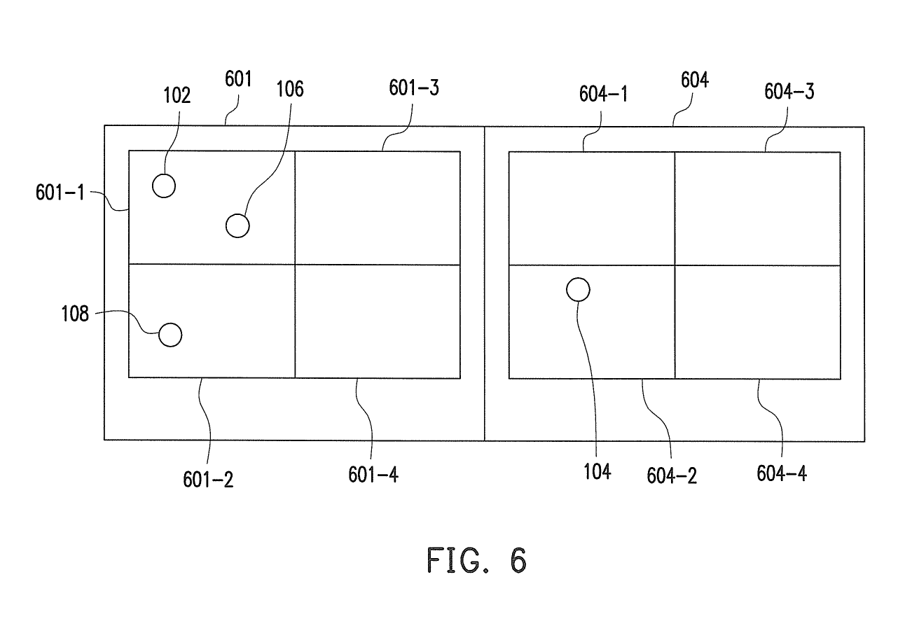

FIG. 7 is a diagram illustrating an example of calculating a match index according to the detail interest classes and the primary interest classes according to an exemplary embodiment of the disclosure.

Referring to FIG. 7, in this example, it is assumed that a primary interest class POI(1) includes detail interest classes POI(1-1), POI(1-2), POI(1-3) and POI(1-4), and according to the detail interest classes and the primary interest classes corresponding to the position coordinates transmitted by the mobile devices of the mobile device users 102, 104, 106 and 108, it is analysed that the mobile device user 102 is interested in the detail interest class POI(1-1) of the primary interest class POI(1); the mobile device user 104 is interested in the detail interest class POI(1-1) of the primary interest class POI(1); the mobile device user 106 is not interested in the primary interest class POI(1); and the mobile device user 108 is interested in the detail interest class POI(1-2) of the primary interest class POI(1). In the example shown in FIG. 7, when the match engine module 512 calculates the match index according to the equation (1), a score between the mobile device user 102 and the mobile device user 104 is the highest, a score between the mobile device user 102 and the mobile device user 108 is the secondary highest, and a score between the mobile device user 102 and the mobile device user 106 is 0. Namely, when the match server 302 provides the match service to the mobile device user 102, the match engine module 512 calculates the number of the common primary interest classes and the number of the common detail interest classes between the mobile device users 102 and 104, the mobile device users 102 and 106, and the mobile device users 102 and 108, so as to calculate the match index between the mobile device user 102 and each of the other mobile device users.

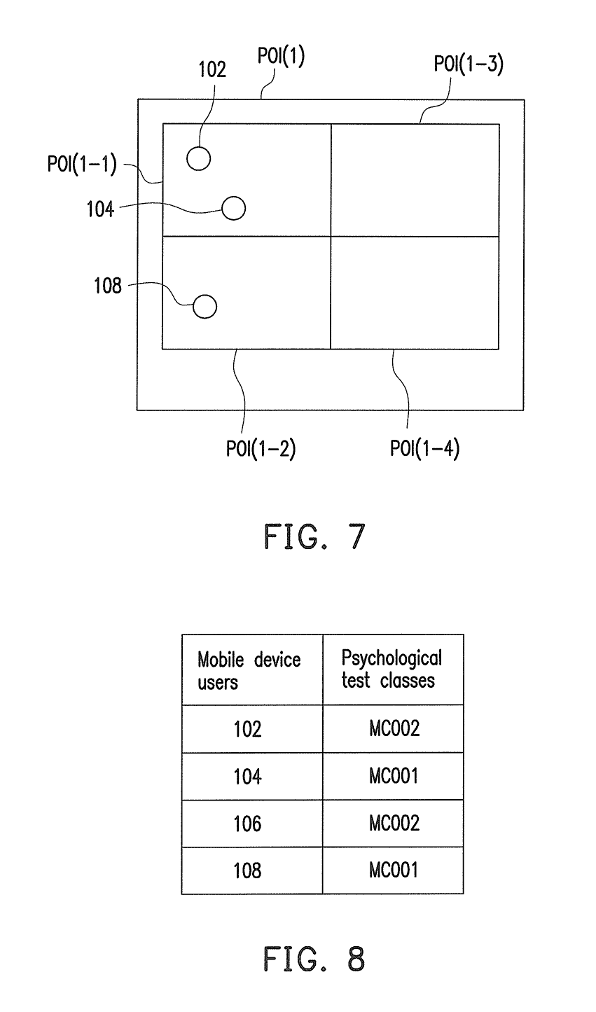

FIG. 8 is a diagram illustrating an example of calculating a match index according to the personal profile attribute classes according to an exemplary embodiment of the disclosure.

Referring to FIG. 8, in this example, it is assumed that the mobile device users 102, 104 and 106 perform a psychological test through the personal profile maintaining module 508, and the mobile device user 108 does not perform the psychological test, wherein the mobile device user 102 is classified into a second class MC0002, the mobile device user 104 is classified into a first class MC0001, the mobile device user 106 is classified into the second class MC0002, and the mobile device user 108 is classified into the first class MC0001. In the example shown in FIG. 8, when the match engine module 512 calculates the match index according to the equation (1), a score between the mobile device user 102 and the mobile device user 106 is the highest, a score between the mobile device user 102 and the mobile device user 104 is 0, and a score between the mobile device user 102 and the mobile device user 108 is also 0. Namely, when the match server 302 provides the match service to the mobile device user 102, the match engine module 512 calculates the number of the common personal profile attribute classes (for example, the psychological test classes) between the mobile device users 102 and 104, the mobile device users 102 and 106, and the mobile device users 102 and 108, so as to calculate the match index between the mobile device user 102 and each of the other mobile device users.

In summary, when the match server 302 provides the match service to the mobile device user 102, the match engine module 512 calculates the number of the common living community reference points, the number of the common living community regions, the number of the common primary interest classes, the number of the common detail interest classes and the number of the common personal profile attribute classes between the mobile device users 102 and the other mobile device users, so as to calculate the match index between the mobile device user 102 and each of the other mobile device users according to the equation (1).

It should be noticed that when the mobile device user is moved to a different position, the corresponding position coordinates may be transmitted to the match server 302 through the mobile device. Particularly, the places with a high appearance frequency or a recent activity range are information worthy of consideration during a matching process. Therefore, in the present exemplary embodiment, the match engine module 512 calculates importance indexes of data of the stored position coordinates or the POI according to a following equation (2), and selects front N batches of data according to the calculated importance indexes to serve as a basis for calculating the match index.

Important(dataₘ)=α×(conut(dataₘ))+(1−α)×(timeorder(dataₘ)) (2)

In the equation (2), dataₘ represents an attribute value of an m-th batch position coordinates (or POI), Important(dataₘ) represents an importance index of the attribute value of the m-th batch position coordinates (or POI), count(dataₘ) represents an accumulation times of the attribute value of the m-th batch position coordinates (or POI), timeorder(dataₘ) represents a update time of the attribute value of the m-th batch position coordinates (or POI), and α is a normalization weight.

After the calculations of the importance index are completed, the match engine module 512 sorts the attribute values in a sequence from the highest importance index to the lowest importance index, and selects the front N batches of attribute values to calculate the match index. Namely, when a number of data batches of the position coordinates (or the POI) of a certain mobile device user in the mobile device user database 510 is greater than N, the match engine module 512 selects N batches of data according to the equation (2) to calculate the match index. Here, N is any suitable number, for example, 100.

In an exemplary embodiment of the disclosure, the living community range defining module 504, the POI inferring module 506, the personal profile maintaining module 508, the mobile device user database 510, the match engine module 512 and the match list transmission module 514 are implemented as a hardware form. However, the disclosure is not limited thereto, and the living community range defining module 504, the POI inferring module 506, the personal profile maintaining module 508, the mobile device user database 510, the match engine module 512 and the match list transmission module 514 can also be implemented as a software form.

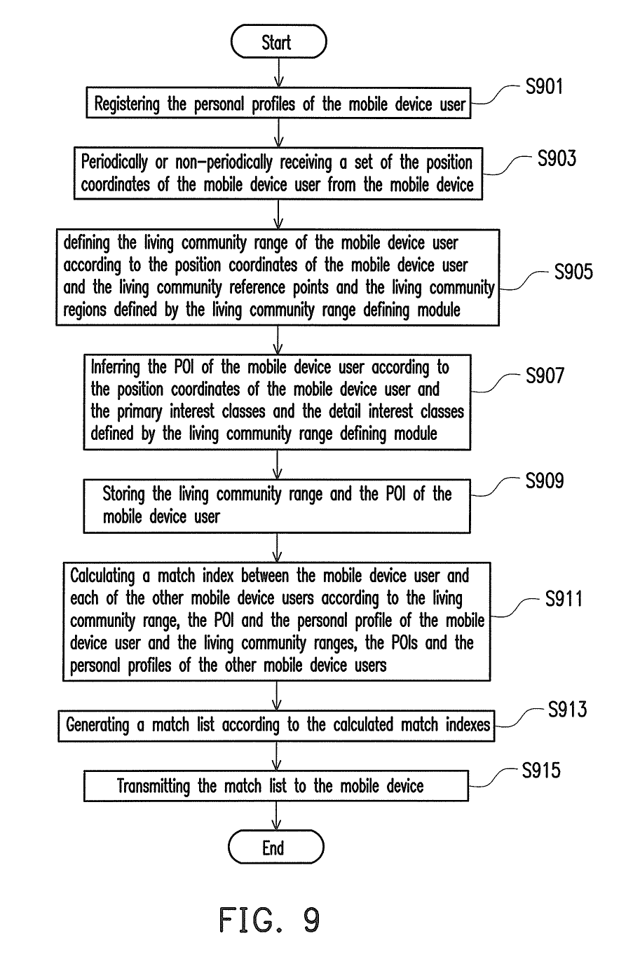

FIG. 9 is a flowchart illustrating a method for matching mobile device users according to an exemplary embodiment of the disclosure.

Referring to FIG. 9, in step S901, the personal profiles of the mobile device user 102 is registered in the match server 302.

Next, in step S903, the match server 302 periodically or non-periodically receives a set of the position coordinates of the mobile device user 102 from the mobile device 202. As described above, the match server 302 successively receives the position coordinates from the mobile device 202 as the mobile device user 102 moves.

In step S905, the match server 302 defines the living community range of the mobile device user 102 according to the position coordinates of the mobile device user 102 and the living community reference points and the living community regions defined by the living community range defining module 504. Next, in step S907, the match server 302 infers the POI of the mobile device user 102 according to the position coordinates of the mobile device user 102 and the primary interest classes and the detail interest classes defined by the living community range defining module 504.

In step S909, the match server 302 stores the living community range and the POI of the mobile device user 102.

Next, in step S911, the match server 302 calculates a match index between the mobile device user 102 and each of the other mobile device users according to the living community range, the POI and the personal profiles of the mobile device user 102 and the living community ranges, the POIs and the personal profiles of the other mobile device users.

After that, in step S913, the match server 302 generates a match list according to the calculated match indexes, and in step S915, the match server 302 transmits the match list to the mobile device.

In the present exemplary embodiment, when the match list transmission module 514 transmits the match list to the mobile device 202, and the mobile device user 102 selects a mobile device user listed in the received match list, the match service module 216 of the mobile device 202 sends a message related to such selection to the match server 302, and the match list transmission module 514 can transmit the closed personal profiles of the selected mobile device user to the mobile device 202 according to a privacy setting of the selected mobile device user. For example, when the mobile devices user 102 selects the mobile device user 106 listed in the match list, the match list transmission module 514 transmits such selection message to the mobile device of the mobile device user 106 through the wireless network unit 502. Then, when the match server 302 receives a reply message from the mobile device user 106, the match list transmission module 514 can transmit the closed personal profiles of the mobile device user 106 to the mobile device 202 according to the reply message (for example, a new privacy setting) of the mobile device user 106.

Particularly, in an exemplary embodiment of the disclosure, the closed personal profiles are gradually transmitted between the mobile device user 102 and the mobile device user 106 according to a plurality of mutual acknowledgements. Namely, the closed personal profiles are gradually transmitted to a counterpart according to updated privacy settings.

For example, a specific position of the mobile device user can be categorized into a position code (for example, 001), a position main name (for example, Taipei city), a position secondary name (for example, Da-an district), a position detail name (for example, Hsin Yi road), and position coordinates (for example, coordinates (123.223, 24.443), wherein the position code is the most abstract, and the position coordinates are the most specific. Here, the match list transmission module 514 first transmits the most abstract position codes to the both sides, and after both sides agree to disclose more information by gradual confirmations, the match list transmission module 514 gradually transmits the closed personal profiles of the position main names, the position secondary names, the position detail names, the position coordinates to the both sides.

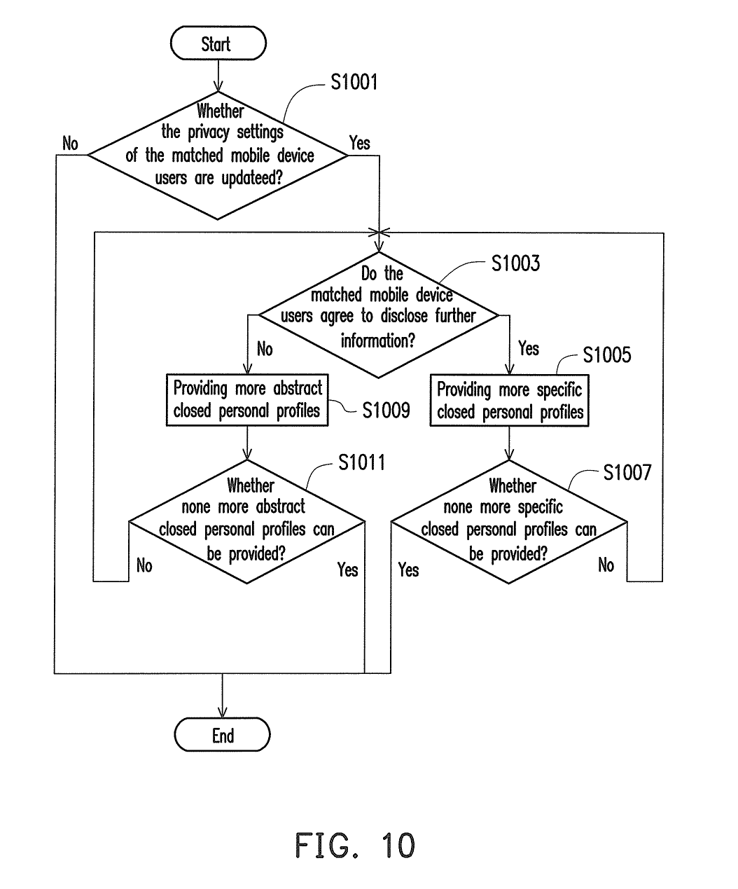

FIG. 10 is a flowchart illustrating a process of gradually disclosing the closed personal profiles according to the privacy setting according to an exemplary embodiment of the disclosure.

Referring to FIG. 10, first, in step S1001, it is determined whether the privacy settings of the matched mobile device users (for example, the mobile device users 102 and 106) are updated. For example, when the matched mobile device users mutually confirm a further communication, the matched mobile device users reset the privacy settings.

If the privacy settings of the matched mobile device users are not updated, the flow of FIG. 10 is ended.

If the privacy settings of the matched mobile device users are updated, in step S1003, it is determined whether the matched mobile device users agree to disclose further information.

If it is determined in the step S1003 that the matched mobile device users agree to disclose the further information, in step S1005, more specific closed personal profiles are provided, and in step S1007, it is determined whether none more specific closed personal profiles can be provided.

If it is determined in the step S1007 that none more specific closed personal profiles can be provided, the process of FIG. 10 is ended. Conversely, the step S1003 is repeated.

If it is determined in the step S1003 that the matched mobile device users do not agree to disclose the further information, in step S1009, relatively abstract closed personal profiles are provided, and in step S1011, it is determined whether none more abstract closed personal profiles can be provided.

If it is determined in the step S1011 that none more abstract closed personal profiles can be provided, the process of FIG. 10 is ended. Conversely, the step S1003 is repeated.

In summary, according to the system and the method for matching the mobile device users of the disclosure, the match can be performed according to actual activity ranges and behavior patterns of the mobile device users, so that the matched mobile device users have a better chance to be the users of a same living community. Moreover, since the personal information of the mobile device users provided by the system and the method for matching the mobile device users of the disclosure are real behaviors, a reliability of the personal information of the mobile device user can be greatly improved.

It will be apparent to those skilled in the art that various modifications and variations can be made to the structure of the disclosure without departing from the scope or spirit of the invention. In view of the foregoing, it is intended that the disclosure cover modifications and variations of this invention provided they fall within the scope of the following claims and their equivalents.

What is claimed is:

1. A system for matching mobile device users, comprising:
a mobile device, corresponding to a mobile device user; and
a match server, receiving a plurality of position coordinates of the mobile device user from the mobile device, and transmitting a match list to the mobile device, wherein the match serve comprises:
a living community range defining module, defining a plurality of living community regions and a plurality of living community reference points in each of the living community regions, and defining a living community range of the mobile device user according to the position coordinates of the mobile device user and the living community reference points and the living community regions;
a point of interest (POI) inferring module, defining a plurality of primary interest classes and a plurality of detail interest classes in each of the primary interest classes, and inferring a POI of the mobile device user according to the position coordinates of the mobile device user and the primary interest classes and the detail interest classes;
a personal profile maintaining module, providing a registration for the mobile device user, and maintaining personal profiles of the mobile device user;
a mobile device user database, storing the living community range, the POI and the personal profiles of the mobile device user, and further storing living community ranges, POIs and personal profiles of a plurality of other mobile device users;
a match engine module, calculating a match index between the mobile device user and each of the other mobile device users according to the living community range, the POI and the personal profiles of the mobile device user and the living community ranges, the POIs and the personal profiles of the other mobile device users; and
a match list transmission module, generating the match list according to the calculated match indexes, and transmitting the match list to the mobile device, wherein the personal profiles of at least one of the other mobile device users are listed in the match list.

2. The system for matching the mobile device users as claimed in claim 1, wherein the living community ranges of the mobile device user and the other mobile device users respectively correspond to at least one of the living community reference points and at least one of the living community regions.

3. The system for matching the mobile device users as claimed in claim 2, wherein the living community range defining module corresponds each of the position coordinates of the mobile device user to one of the living community reference points according to distances between each of the position coordinates of the mobile device user and the living community reference points, and the living community range defining module corresponds each of the position coordinates of the mobile device user to one of the living community regions according to distances between each of the position coordinates of the mobile device user and the living community regions.

4. The system for matching the mobile device users as claimed in claim 1, wherein the POIs of the mobile device user and the other mobile device users respectively correspond to at least one of the primary interest classes and at least one of the detail interest classes.

5. The system for matching the mobile device users as claimed in claim 4, wherein the POI inferring module corresponds each of the position coordinates of the mobile device user to one of the primary interest classes according to distances between each of the position coordinates of the mobile device user and the living community reference points, and the POI inferring module corresponds each of the position coordinates of the mobile device user to one of the detail interest classes according to distances between each of the position coordinates of the mobile device user and the living community reference points.

6. The system for matching the mobile device users as claimed in claim 1, wherein the mobile device has a positioning unit, and the positioning unit is configured for obtaining the position coordinates of the mobile device user at different time points.

7. The system for matching the mobile device users as claimed in claim 6, wherein the positioning unit is a global positioning system (UPS) receiver.

8. The system for matching the mobile device users as claimed in claim 1, wherein the personal profile maintaining module provides an interactive question and answer interface or an interactive game interface for obtaining the personal profiles of the mobile device user.

9. The system for matching the mobile device users as claimed in claim 8, further comprising a network terminal, wherein the personal profile maintaining module transmits the interactive question and answer interface or the interactive game interface to the network terminal through a network, and the mobile device user inputs the personal profiles through the interactive question and answer interface or the interactive game interface displayed on the network terminal or the mobile device.

10. The system for matching the mobile device users as claimed in claim 1, wherein the personal profiles comprise open personal profiles and closed personal profiles, and the personal profiles listed in the match list are the open personal profiles.

11. The system for matching the mobile device users as claimed in claim 10, wherein the mobile device comprises a match service module, wherein the match service module is configured for displaying the match list, and allowing the mobile device user to select at least one of the other mobile device users listed in the match list.

12. The system for matching the mobile device users as claimed in claim 11, wherein the match list transmission module transmits at least a part of the closed personal profiles of the selected other mobile device user to the mobile device according to a privacy setting set by the selected other mobile device user, and the match service module displays at least a part of the closed personal profiles of the selected other mobile device user.

13. The system for matching the mobile device users as claimed in claim 12, wherein the match list transmission module gradually transmits at least a part of the closed personal profiles of the selected other mobile device user according to the privacy setting set by the selected other mobile device user.

14. A method for matching mobile device users, comprising:
receiving a plurality of position coordinates of a mobile device user from a mobile device, wherein the mobile device is used by the mobile device user;
defining a plurality of living community regions and a plurality of living community reference points in each one of the living community regions;
defining a living community range of the mobile device user according to the position coordinates of the mobile device user and the living community reference points and the living community regions;
defining a plurality of primary interest classes and a plurality of detail interest classes in each of the primary interest classes;
inferring a POI of the mobile device user according to the position coordinates of the mobile device user and the primary interest classes and the detail interest classes;
storing the living community range, the POI and personal profiles of the mobile device user in a mobile device user database, wherein the mobile device user database further stores living community ranges, POIs and personal profiles of a plurality of other mobile device users;
calculating a match index between the mobile device user and each of the other mobile device users according to the living community range, the POI and the personal profiles of the mobile device user and the living community ranges, the POIs and the personal profiles of the other mobile device users;
generating a match list according to the calculated match indexes, wherein the personal profiles of at least one of the other mobile device users are listed in the match list; and
transmitting the match list to the mobile device.

15. The method for matching mobile device users as claimed in claim 14, further comprising respectively corresponding the living community ranges of the mobile device user and the other mobile device users to at least one of the living community reference points and at least one of the living community regions.

16. The method for matching mobile device users as claimed in claim 15, wherein the step of defining the living community range of the mobile device user according to the position coordinates of the mobile device user and the defined living community reference points and the living community regions comprises:
corresponding each of the position coordinates of the mobile device user to one of the living community reference points according to distances between each of the position coordinates of the mobile device user and the living community reference points; and
corresponding each of the position coordinates of the mobile device user to one of the living community regions according to distances between each of the position coordinates of the mobile device user and the living community regions.

17. The method for matching mobile device users as claimed in claim 14, further comprising respectively corresponding the POIs of the mobile device user and the other mobile device users to at least one of the primary interest classes and at least one of the detail interest classes.

18. The method for matching mobile device users as claimed in claim 17, wherein the step of inferring the POI of the mobile device user according to the position coordinates of the mobile device user and the defined primary interest classes and the detail interest classes comprises:
corresponding each of the position coordinates of the mobile device user to one of the primary interest classes according to distances between each of the position coordinates of the mobile device user and the living community reference points; and
corresponding each of the position coordinates of the mobile device user to one of the detail interest classes according to distances between each of the position coordinates of the mobile device user and the living community reference points.

19. The method for matching mobile device users as claimed in claim 14, further comprising obtaining the position coordinates of the mobile device user by the mobile device at different time points.

20. The method for matching mobile device users as claimed in claim 19, wherein the step of obtaining the position coordinates of the mobile device user by the mobile device at different time points comprises:
obtaining the position coordinates of the mobile device user by the mobile device through a global positioning system (GPS).

21. The method for matching mobile device users as claimed in claim 14, further comprising providing an interactive question and answer interface or an interactive game interface for obtaining the personal profiles of the mobile device user.

22. The method for matching mobile device users as claimed in claim 14, wherein the personal profiles comprise open personal profiles and closed personal profiles, and the personal profiles listed in the match list are the open personal profiles.

23. The method for matching mobile device users as claimed in claim 22, further comprising displaying the match list by the mobile device.

24. The method for matching mobile device users as claimed in claim 23, further comprising selecting at least one of the other mobile device users listed in the match list by the mobile device user.

25. The method for matching mobile device users as claimed in claim 24, further comprising:
transmitting at least a part of the closed personal profiles of the selected other mobile device user to the mobile device according to a privacy setting set by the selected other mobile device user; and
displaying at least a part of the closed personal profiles of the selected other mobile device user by the mobile device.

26. The method for matching mobile device users as claimed in claim 25, wherein the step of transmitting at least a part of the closed personal profiles of the selected other mobile device user to the mobile device according to the privacy setting set by the selected other mobile device user comprises:
gradually transmitting at least a part of the closed personal profiles of the selected other mobile device user according to the privacy setting set by the selected other mobile device user.
